(19) United States
(12) Patent Application Publication
(10) Pub. No.: US 2023/0003840 A1
(43) Pub. Date: Jan. 5, 2023

(54) DISTANCE MEASUREMENT DEVICE

(71) Applicant: DENSO CORPORATION, Kariya-city (JP)

(72) Inventor: Masahiro YAMAMOTO, Kariya-city (JP)

(21) Appl. No.: 17/930,669

(22) Filed: Sep. 8, 2022

Related U.S. Application Data
(63) Continuation of application No. PCT/JP2021/009813, filed on Mar. 11, 2021.

(30) Foreign Application Priority Data
Mar. 11, 2020 (JP) 2020-042304

(51) Int. Cl. G01S 7/481; G01S 17/08

(52) U.S. Cl. CPC G01S 7/4813; G01S 17/08

(57) ABSTRACT

A flexible substrate includes a heater portion and a wiring portion. A heater wire is formed in the heater portion. The heater portion is fixed to a transparent window. In the wiring portion, a wiring to the heater wire is formed. The wiring portion extends to a rear side of a casing in a case where a side on which the transparent window is provided in the casing is set as a front side. A fixing member fixes the wiring portion within the casing. A light shielding member is constituted to shield stray light from the fixing member toward a detection unit.

### CROSS-REFERENCE TO RELATED APPLICATION

This application is a continuation application of International Application No. PCT/JP2021/009813 filed Mar. 11, 2021 which designated the U.S. and claims priority to Japanese Patent Application No. 2020-042304 filed Mar. 11, 2020, the contents of each of which are incorporated herein by reference.

### BACKGROUND

### Technical Field

The present disclosure relates to a distance measurement device.

### Related Art

As a distance measurement device that is mounted on a vehicle and measures a distance to an object in front of the vehicle, there is a distance measurement device that radiates light forward, detects reflected light of the radiated light from the object and measures a distance to the object.

### BRIEF DESCRIPTION OF THE DRAWINGS

In the accompanying drawings:

FIG. 1 is a perspective view illustrating the overall appearance of a distance measurement device;

FIG. 2 is a perspective view illustrating a configuration of a detection module;

FIG. 3 is a schematic view illustrating a configuration of inside of a casing viewed from a front side;

FIG. 4 is a perspective view illustrating a position of a light shielding member inside a cover;

FIG. 5 is a view illustrating a configuration of an inner surface of the cover;

FIG. 6 is a view illustrating a flexible substrate;

FIG. 7 is a view illustrating a rear surface of the flexible substrate;

FIG. 8 is a front view of a casing body;

FIG. 9 is a perspective view illustrating the light shielding member viewed from a guide surface side;

FIG. 10 is a perspective view illustrating the light shielding member viewed from above on an opposite side of the guide surface;

FIG. 11 is a perspective view illustrating the light shielding member viewed from below on an opposite side of the guide surface;

FIG. 12 is a front view of the light shielding member;

FIG. 13 is a right side view of the light shielding member;

FIG. 14 is a top view of the light shielding member;

FIG. 15 is a left side view of the light shielding member;

FIG. 16 is a bottom view of the light shielding member; and

FIG. 17 is a schematic view illustrating a relationship between a body portion of the light shielding member and a scanning region.

### DESCRIPTION OF SPECIFIC EMBODIMENTS

A distance measurement device typically has a casing, inside of which an irradiation unit that radiates light and a detection unit that detects reflected light are stored. In a front portion of the casing, a transparent window through which the radiated light and the reflected light pass is provided.

However, if snow, rainwater, or the like, is attached to the transparent window, there is a case where measurement accuracy of the distance measurement device may degrade.

Thus, US 2014/0320845 A1 discloses providing at a transparent window, a heater that heats the transparent window to remove snow, rainwater, or the like, attached to the transparent window.

The present inventors studied a configuration in which a flexible substrate on which a heater wire is formed is adhered to a transparent window as a configuration of a distance measurement device with a heater provided on the transparent window. In this case, there is a possible configuration in which a portion in which a wiring to the heater wire is formed (hereinafter, referred to as a wiring portion) on the flexible substrate is drawn out from a drawing hole provided in a rear portion of a casing to outside of the casing to electrically connect the heater wire to a power supply provided outside on a rear side of the casing. In a case of such a configuration, if an attempt is made to insert the wiring portion into the drawing hole in a state where a portion in which the heater wire is formed (hereinafter, referred to as a heater portion) on the flexible substrate is adhered to the transparent window, the wiring portion is pulled when the wiring portion is inserted into the drawing hole, and force is also applied to the heater portion, which may lead to a risk of partial peeling of the heater portion from the transparent window.

To avoid such a situation, there is a possible method in which a fixing member for fixing the wiring portion is provided to fix the wiring portion within the casing, for example, by adhering the wiring portion on an inner surface of the casing with an adhesive tape.

Meanwhile, stray light may be generated inside the casing as a result of radiation light or reflected light being reflected at an optical window, or the like. As a result of study, the present inventors have found that there is a problem of decrease in distance measurement accuracy due to stray light being reflected at a fixing member for fixing the wiring portion and detected at the detection unit.

In view of the foregoing, it is desired to have a distance measurement device for which degradation in distance measurement accuracy due to stray light is prevented.

One aspect of the present disclosure is a distance measurement device that measures a distance to an object, the distance measurement device including a detection module, a casing, a transparent window, and a flexible substrate. The detection module includes an irradiation unit and a detection unit. The irradiation unit radiates radiation light for performing scanning along a scanning direction set in advance. The detection unit detects reflected light from an object, arriving from a scanning region. The casing stores the detection module. The transparent window, which is part of the casing, is disposed to face the detection module. The radiation light and the reflected light pass through the transparent window. A heater wire that heats the transparent window is formed on the flexible substrate. Further, the flexible substrate includes a heater portion and a wiring portion. The heater wire is formed in the heater portion. The heater portion is fixed to the transparent window. A wiring to the heater wire is formed in the wiring portion. The wiring portion extends to a rear side of the casing in a case where a side on which the transparent window is provided in the casing is set as a front side. The distance measurement device further includes a fixing member and a light shielding member. The fixing member fixes the wiring portion within the casing. The light shielding member is configured to shield stray light from the fixing member toward the detection unit.

According to such a configuration, a distance measurement device for which degradation of distance measurement accuracy due to stray light is prevented is provided.

An illustrative embodiment of the present disclosure will be described below with reference to the drawings.

### 1. Overall Configuration

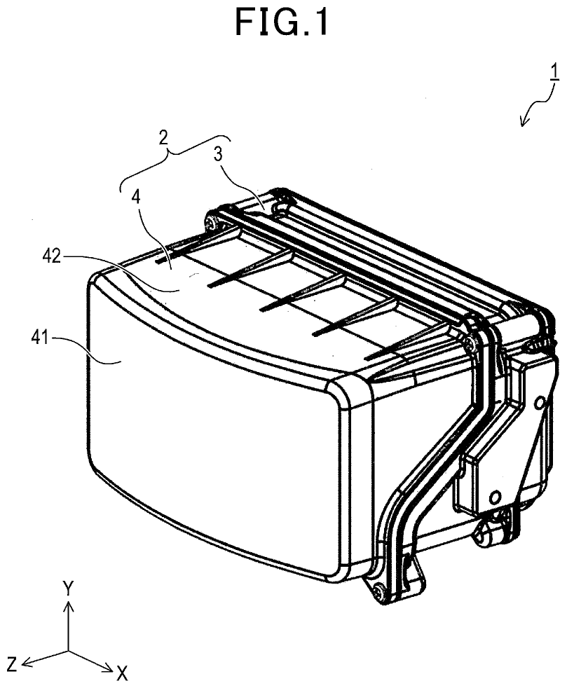

A distance measurement device 1 illustrated in FIG. 1 is a LIDAR device that measures a distance to an object by radiating radiation light and detecting reflected light from the object irradiated with the radiation light. LIDAR is an abbreviation of light detection and ranging. The distance measurement device 1 is used while being mounted on a vehicle and is used to detect various objects located in front of the vehicle.

As illustrated in FIG. 1, the distance measurement device 1 includes a casing 2. The casing 2 is a resin box formed in a rectangular parallelepiped shape.

The casing 2 includes a casing body 3 and a cover 4. A transparent window 41 through which radiation light and reflected light pass is provided on a front side of the cover 4 as part of the cover 4. The front side described here indicates a direction of a radiation destination of radiation light in the casing 2.

Hereinafter, a horizontal direction in a case where the transparent window 41 is viewed from the front in a state where the distance measurement device 1 is provided in the vehicle will be referred to as an X axis direction, a vertical direction in a case where the transparent window 41 is viewed from the front will be referred to as a Y axis direction, and a direction orthogonal to an X-Y plane will be referred to as a Z axis direction. The Z axis direction will be also referred to as a longitudinal direction of the casing 2.

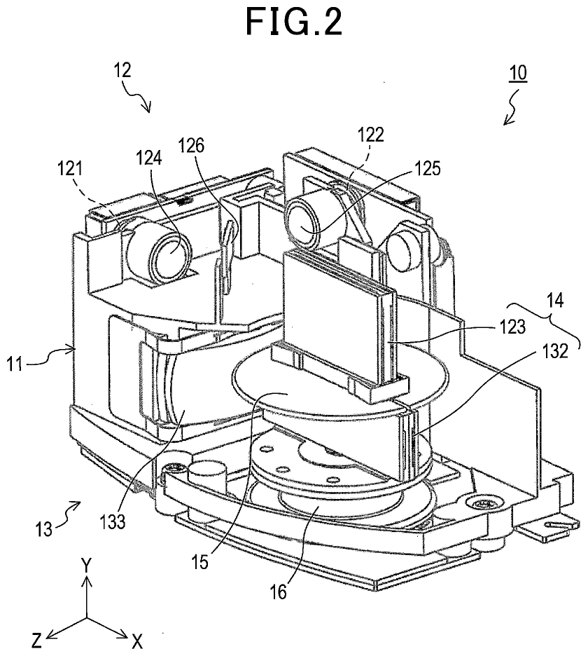

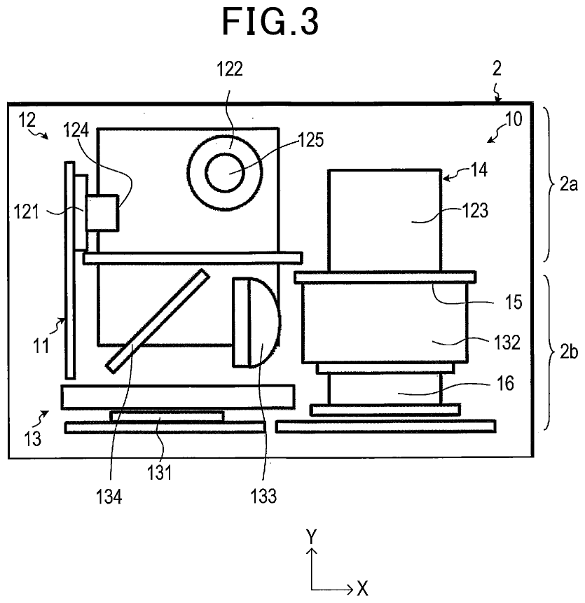

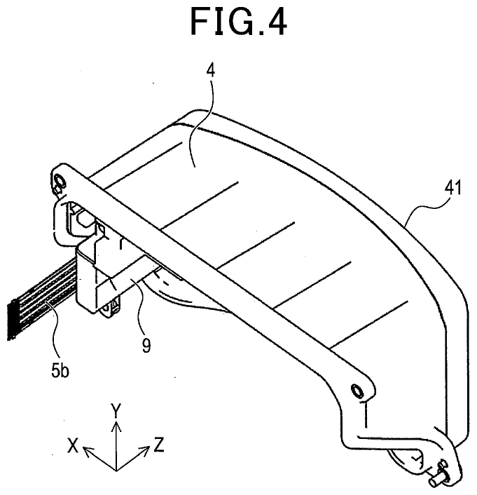

A detection module 10 illustrated in FIG. 2 and FIG. 3 is stored inside the casing 2. The detection module 10 is assembled to the casing body 3 via a frame 11 constituted with a plurality of parts. Further, inside the casing 2, as illustrated in FIG. 4, a light shielding member 9 is stored in a void between the detection module 10 and a right surface of the casing 2. The light shielding member 9 is also assembled to the casing body 3.

A configuration of the detection module 10, a configuration of the cover 4, a configuration of a flexible substrate 5 provided at the transparent window 41 and a configuration of the light shielding member 9 will be described in detail below.

### 2. Configuration of Detection Module

As illustrated in FIG. 2 and FIG. 3, the detection module 10 includes an irradiation unit 12, a detection unit 13, an intermediate plate 15 provided between the irradiation unit 12 and the detection unit 13, and a motor 16. Note that in FIG. 3, most parts of the frame 11 are omitted to facilitate visualization of the configuration of the detection module 10.

The configuration of the detection module 10 will be described in detail below.

### 2-1. Irradiation Unit

The irradiation unit 12, which is stored in an upper space inside the casing 2, radiates radiation light for performing scanning along a scanning direction set in advance.

As illustrated in FIG. 2, the irradiation unit 12 includes two light sources 121 and 122, and an irradiation mirror 123. Further, the irradiation unit 12 may include two irradiation side lenses 124 and 125, and an irradiation side fold mirror 126.

Semiconductor lasers are used for both the two light sources 121 and 122.

The irradiation mirror 123 is a plate-like member in which a pair of deflecting mirrors that reflect light is attached to both surfaces. The irradiation mirror 123 rotationally moves around a rotation axis along the Y axis direction in accordance with drive of the motor 16 which will be described later.

The irradiation side lens 124 is a lens disposed so as to face a light emitting surface of the light source 121. In a similar manner, the irradiation side lens 125 is a lens disposed so as to face a light emitting surface of the light source 122.

The irradiation side fold mirror 126 is a mirror that changes a light traveling direction.

The light source 121 is disposed so that light that is output from the light source 121 and passes through the irradiation side lens 124 is incident on the irradiation mirror 123 as is.

The light source 122 and the irradiation side fold mirror 126 are disposed so that light that is output from the light source 122 and passes through the irradiation side lens 125 is incident on the irradiation mirror 123 after a traveling direction is bent by substantially 90° at the irradiation side fold mirror 126.

Here, the light source 121 is disposed in a left portion of the casing 2 so as to output light rightward, and the light source 122 is disposed in a rear portion of the casing 2 so as to output light forward. Further, the irradiation side fold mirror 126 is disposed so as not to shield light from the light source 121 toward the irradiation mirror 123.

The irradiation unit 12 is constituted to operate as follows to radiate light. The light output from the light source 121 is incident on the irradiation mirror 123 via the irradiation side lens 124. Further, the light output from the light source 122 passes through the irradiation side lens 125 and is incident on the irradiation mirror 123 after a traveling direction is bent by substantially 90° at the irradiation side fold mirror 126. The light incident on the irradiation mirror 123 is emitted in a direction in accordance with a rotation angle of the irradiation mirror 123 via the transparent window 41. A region in which light is radiated via the irradiation mirror 123 is a scanning region. For example, a range of ±60° expanding in the X axis direction assuming that a front direction along the Z axis is 0 degree can be set as the scanning region.

### 2-2. Detection Unit

The detection unit 13, which is stored in a lower space inside the casing 2, detects reflected light from an object, arriving from the scanning region.

As illustrated in FIG. 3, the detection unit 13 includes a light reception element 131 and a detection mirror 132. The detection unit 13 may include a detection side lens 133 and a detection side fold mirror 134.

The light reception element 131 includes an APD array in which a plurality of APDs are arranged in line. APD is an abbreviation for avalanche photodiode.

The detection mirror 132 is a plate-like member in which a pair of deflecting mirrors that reflect light is attached on respective surfaces in a similar manner to the irradiation mirror 123. Further, the detection mirror 132 rotationally moves around a rotation axis along the Y axis direction in accordance with drive of the motor 16 which will be described later in a similar manner to the irradiation mirror 123.

The detection side lens 133 is a lens that converges light arriving from the scanning region.

The detection side fold mirror 134 is a mirror that changes a light traveling direction.

The light reception element 131 is disposed below the detection side fold mirror 134.

The detection side fold mirror 134 is disposed so as to bend a light path downward by substantially 90° so that light incident from the detection mirror 132 via the detection side lens 133 reaches the light reception element 131.

The detection side lens 133 is disposed between the detection mirror 132 and the detection side fold mirror 134. The detection side lens 133 converges a light beam incident on the light reception element 131 so that a beam diameter becomes approximately a width of an element of the APD.

The detection unit 13 operates as follows to detect reflected light from the object. The reflected light from the object located in a predetermined direction in accordance with a rotation angle of the detection mirror 132, that is, in a direction of light emission from the irradiation mirror 123 passes through the transparent window 41 of the casing 2 and is incident on the detection mirror 132. The reflected light is reflected at the detection mirror 132 and is detected at the light reception element 131 via the detection side lens 133 and the detection side fold mirror 134.

### 2-3. Intermediate Plate and Motor

The intermediate plate 15 is a circular plate-like member that is provided between the irradiation mirror 123 and the detection mirror 132 and extends in a horizontal direction. As illustrated in FIG. 3, the intermediate plate 15 is a divider that divides inside of the casing 2 into a space 2a in which the irradiation unit 12 is provided and a space 2b in which the detection unit 13 is provided.

The irradiation mirror 123 and the detection mirror 132 are collectively referred to as a mirror module 14. The mirror module 14 and the intermediate plate 15 are constituted in an integrated manner.

The motor 16, which is disposed below the mirror module 14, causes the mirror module 14 and the intermediate plate 15 to rotationally move around a rotation axis along the Y axis direction.

### 3. Configuration of Cover

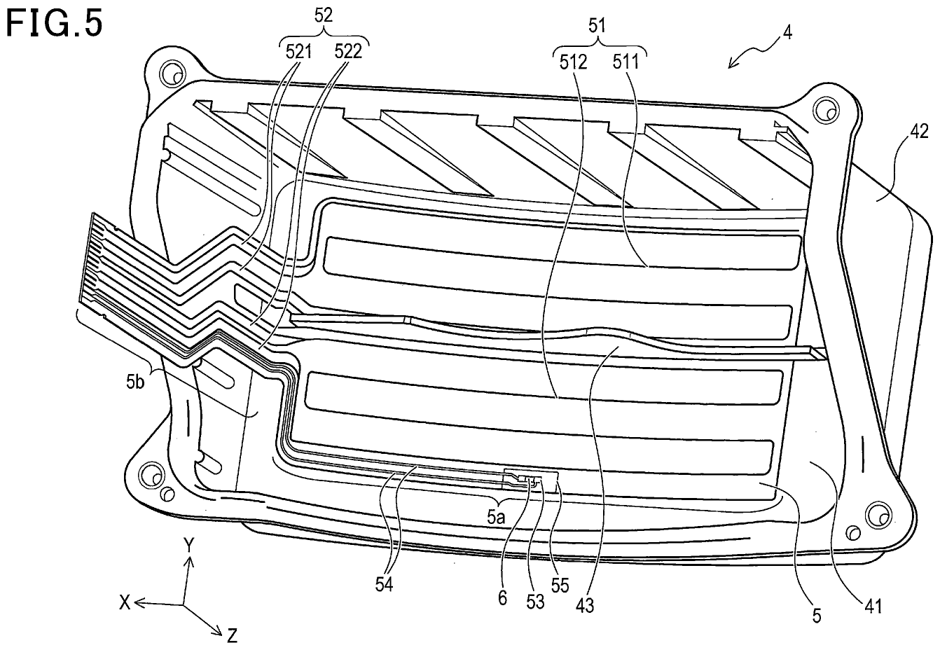

As illustrated in FIG. 1 and FIG. 5, the cover 4 includes the transparent window 41, a frame body 42, and a transparent window shielding plate 43 provided on an inner surface of the transparent window 41.

As described above, the transparent window 41 is a portion of the cover 4, which is disposed so as to face the detection module 10 and through which radiation light and reflected light pass. The transparent window 41 is formed in a curved surface shape that is convex toward outside of the casing 2.

The frame body 42 is a portion having a frame shape, which extends rearward from an outer periphery of the transparent window 41. The frame body 42 is formed with a resin material that inhibits passing of laser light emitted from the two light sources 121 and 122.

As illustrated in FIG. 5, the transparent window shielding plate 43 is a plate-like member provided along the X axis direction so as to project from an inner surface of the transparent window 41. The transparent window shielding plate 43 divides a space between the mirror module 14 and the transparent window 41 into a space on the irradiation unit 12 side and a space on the detection unit 13 side. The transparent window shielding plate 43, which is formed with a resin material that inhibits passing of the laser light emitted from the two light sources 121 and 122, prevents radiation light diffusely reflected within the space 2a in which the irradiation unit 12 is provided inside the casing 2 from being incident on the space 2b in which the detection unit 13 is provided.

As illustrated in FIG. 5, the flexible substrate 5 on which the heater wire 51 that heats the transparent window 41 is formed is adhered to the inner surface of the transparent window 41.

### 4. Configuration of Flexible Substrate

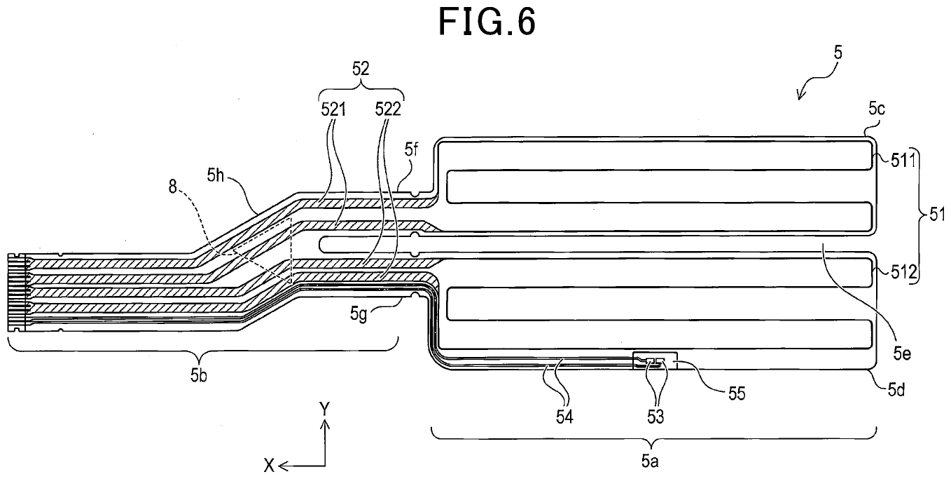

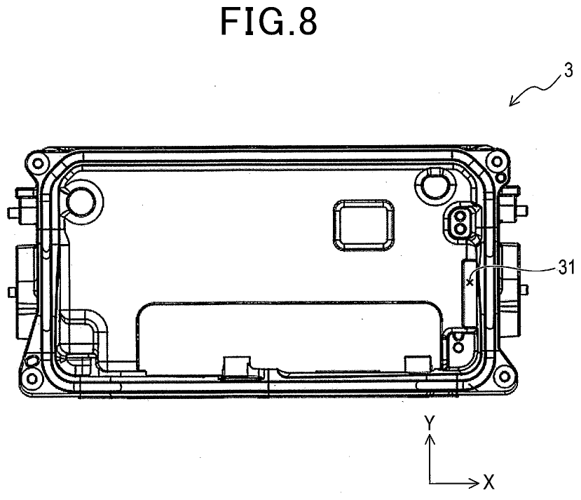

As illustrated in FIG. 5 and FIG. 6, the flexible substrate 5 is a printed circuit board on which various kinds of wiring patterns are formed on a film-like insulating substrate. The flexible substrate 5 includes a heater portion 5a to be adhered on the inner surface of the transparent window 41, and a wiring portion 5b bent at an end portion on the inner surface of the transparent window 41 and extending to a rear side of the casing 2 as illustrated in FIG. 4. The wiring portion 5b has a width in the Y axis direction thinner than a width of the heater portion 5a. The wiring portion 5b is inserted into a drawing hole 31 which is illustrated in FIG. 8 and which is provided on a surface facing the transparent window 41 in the casing body 3 and is connected to an external power supply.

The heater wire 51, a wiring 52 (hereinafter, referred to as a “heater wiring 52”) to the heater wire 51, two lands 53 for mounting a thermistor 6, and a wiring 54 (hereinafter, referred to as a “thermistor wiring 54”) to the thermistor 6 to be connected to the lands 53 are formed on the flexible substrate 5. These are formed by laminating a conductor layer on a surface of a film-like insulating material and etching the conductor layer. Copper is preferably used as a conductor. Note that FIG. 6 illustrates a state where the thermistor 6 is not mounted.

The heater wire 51 is formed in the heater portion 5a on the flexible substrate 5. The heater wire 51 includes an irradiation side heater wire 511 that heats a region through which radiation light passes, and a detection side heater wire 512 that heats a region through which reflected light to be detected by the detection unit 13 passes.

As illustrated in FIG. 6, the flexible substrate 5 is divided into an irradiation side heater portion 5c in which the irradiation side heater wire 511 is formed and a detection side heater portion 5d in which the detection side heater wire 512 is formed, in the heater portion 5a. A void 5e is formed between the irradiation side heater portion 5c and the detection side heater portion 5d. As illustrated in FIG. 5, the transparent window shielding plate 43 is positioned in the void 5e in a state where the heater portion 5a is adhered to the inner surface of the transparent window 41.

The heater wiring 52, which is mainly formed in the wiring portion 5b, is connected to the heater wire 51 near a boundary between the heater portion 5a and the wiring portion 5b. The heater wiring 52 includes an irradiation side heater wiring 521 to be connected to the irradiation side heater wire 511, and a detection side heater wiring 522 to be connected to the detection side heater wire 512.

The land 53 is formed in a region in which the heater wire 51 is not formed in the heater portion 5a. Specifically, the land 53 is formed below the detection side heater wire 512 near a center of the detection side heater portion 5d.

The thermistor wiring 54 is formed to extend to the heater portion 5a from the wiring portion 5b, and a terminal of the thermistor wiring 54 is connected to the land 53.

An outermost surface of the flexible substrate 5 is covered with an insulating resin film to protect these wiring patterns. An opening 55 is formed at part of the resin film, and the land 53 is exposed from the opening 55. The land 53 is protected by Ni plating, gold plating, or the like, further applied on the conductor layer.

The thermistor 6 is mounted on the land 53 as illustrated in FIG. 5. The thermistor 6 detects a temperature of the transparent window 41 to be used to control heating of the transparent window 41 using the heater wire 51.

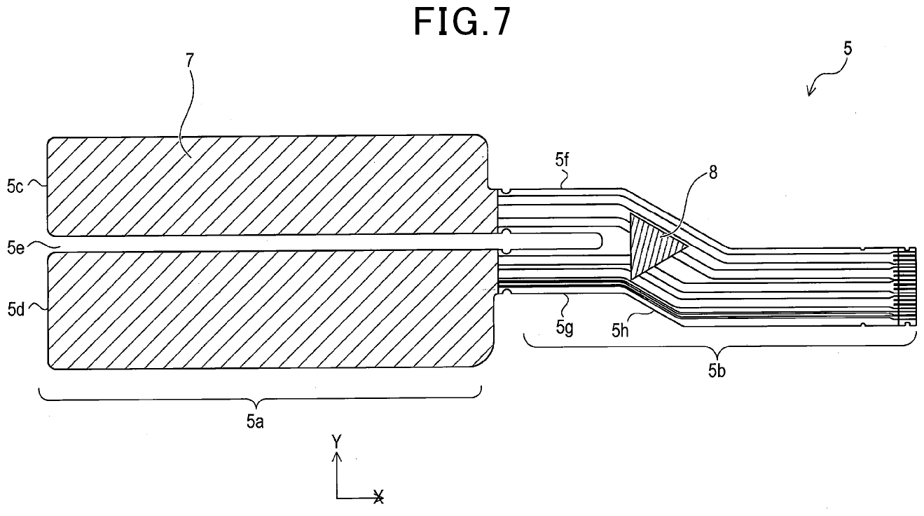

As illustrated in FIG. 7, a fixing member 7 for heater portion that fixes the heater portion 5a to the transparent window 41 and a fixing member 8 for wiring portion that fixes the wiring portion 5b to a right surface of the casing 2 are provided on a surface opposite to a surface on which the thermistor 6 is mounted on the flexible substrate 5.

The fixing member 7 for heater portion is a sheet-like optically clear adhesive that is typically called OCA. OCA is an abbreviation of optically clear adhesive. The OCA is used so that light is less likely to be reflected on an interface between the fixing member 7 for heater portion, and the flexible substrate 5 and the transparent window 41, because the radiation light and the reflected light directly pass through the heater portion 5a.

On the other hand, the fixing member 8 for wiring portion is a typical adhesive tape which is not the OCA. Unlike with the heater portion 5a, the radiation light and the reflected light do not directly pass through the wiring portion 5b, and thus, a common adhesive tape that is cheaper than the OCA is used. The fixing member 8 for wiring portion is provided in an integrated portion 5h obtained by integrating a portion 5f extending from the irradiation side heater portion 5c and a portion 5g extending from the detection side heater portion 5d in the wiring portion 5b.

### 5. Configuration of Light Shielding Member

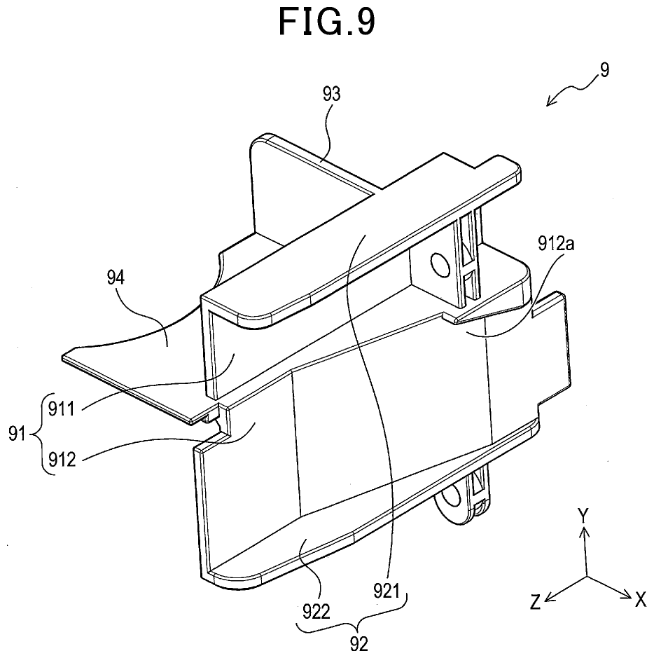

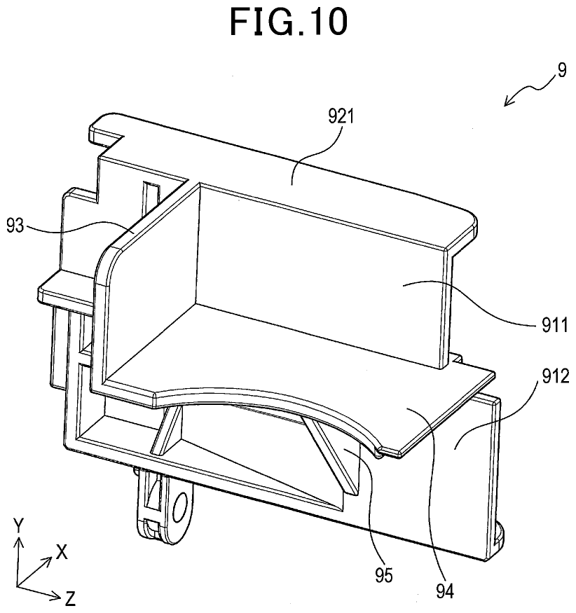

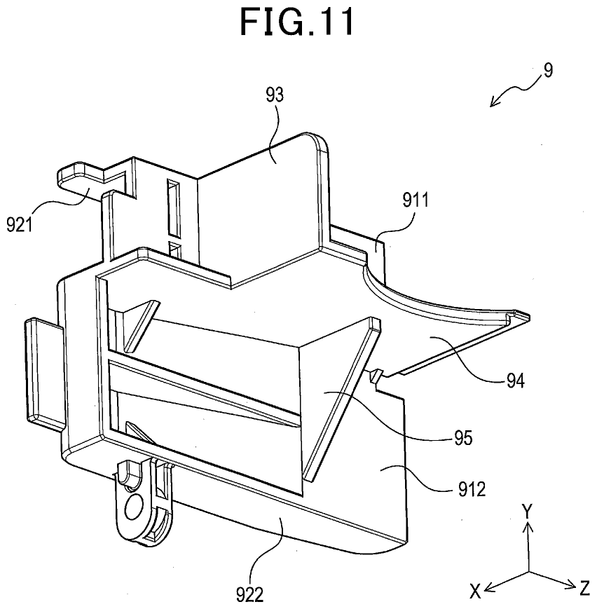

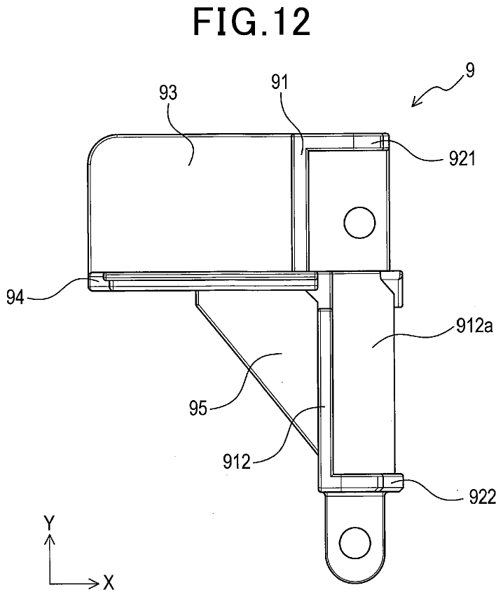

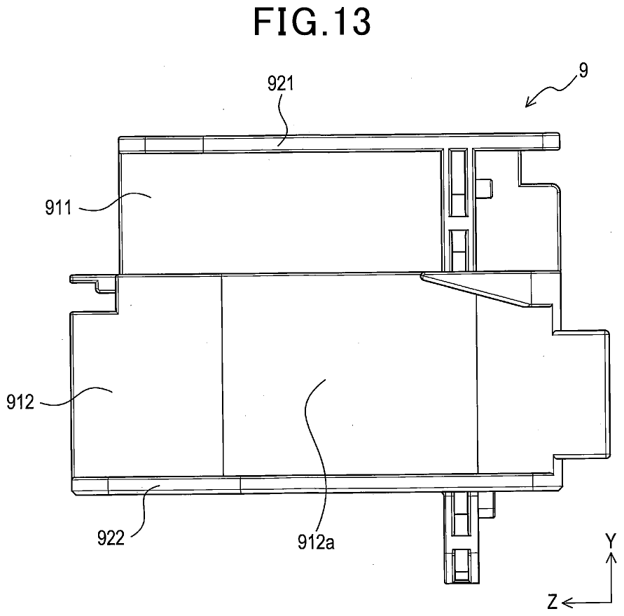

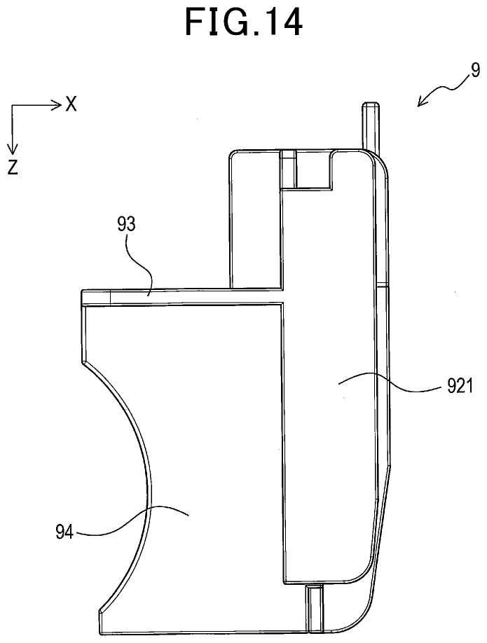

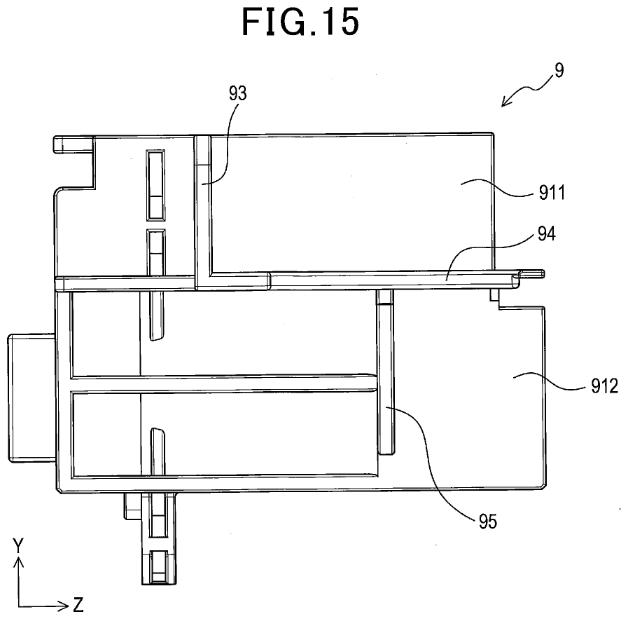

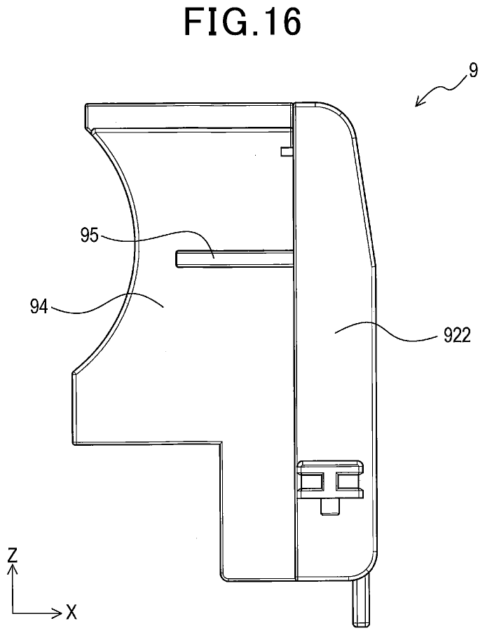

As illustrated in FIG. 9 to FIG. 16, the light shielding member 9 includes a body portion 91, a protruding portion 92, a shielding portion 93, a dividing portion 94, and a reinforcing plate 95. The light shielding member 9 is formed with a resin material that inhibits passing of the laser light emitted from the two light sources 121 and 122.

The body portion 91 is a plate-like portion. The body portion 91 is positioned between the detection module 10 and the right surface of the casing 2 and extends in a longitudinal direction along the right surface of the casing 2. Specifically, the body portion 91 includes an irradiation side body portion 911 positioned in the space 2a in which the irradiation unit 12 is provided, and a detection side body portion 912 positioned in the space 2b in which the detection unit 13 is provided.

In the detection side body portion 912, a surface facing the right surface of the casing 2 is a guide surface 912a constituted to guide the wiring portion 5b of the flexible substrate 5 toward the drawing hole 31. In a situation in which the cover 4 is assembled to the casing body 3, first, a tip of the wiring portion 5b is inserted into a void space between the detection side body portion 912 and a right surface of the casing body 3. Then, if the cover 4 relatively moves to the casing body 3 so that the cover 4 comes closer to the casing body 3, the wiring portion 5b advances toward a surface on a rear side of the casing 2 in the void space along the guide surface 912a. Eventually, the tip of the wiring portion 5b reaches the drawing hole 31 and further advances to outside of the casing 2 through the drawing hole 31.

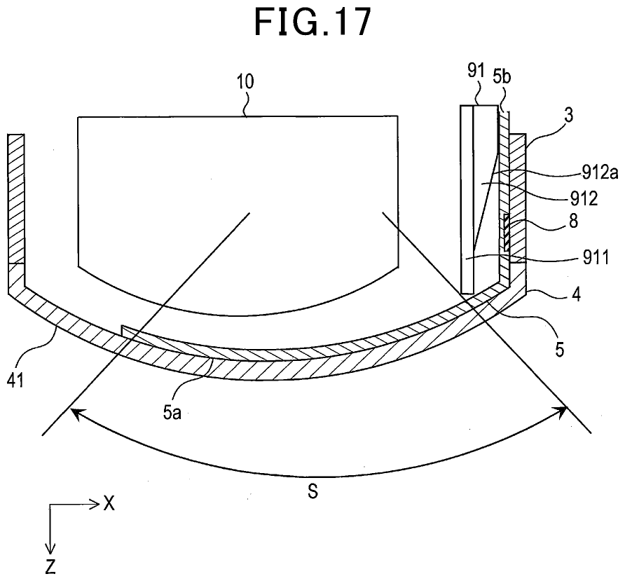

As illustrated in a schematic view in FIG. 17, a portion on the front side in the body portion 91 shields light which arrives from a space outside the scanning region S and is incident on the detection unit 13 through a right end portion of the transparent window 41. Note that in the schematic view in FIG. 17, portions such as the protruding portion 92 other than the body portion 91 of the light shielding member 9 are omitted. Further, the detection side body portion 912 in the body portion 91 exists at a position that divides a space into a space in which the fixing member 8 for wiring portion exists and a space in which the detection module 10 exists and shields stray light from the fixing member 8 for wiring portion toward the detection unit 13.

Returning to FIG. 9 to FIG. 16, the protruding portion 92 is a plate-like portion that protrudes from the body portion 91 toward the right surface of the casing 2. Specifically, the protruding portion 92 includes an irradiation side protruding portion 921 that protrudes from an upper end of the irradiation side body portion 911 and is provided along an upper surface of the casing 2 and a detection side protruding portion 922 that protrudes from a lower end of the detection side body portion 912 and is provided along a lower surface of the casing 2. The protruding portion 92 covers the wiring portion 5b along with the body portion 91 and prevents stray light from a space in which the wiring portion 5b exists from being incident on a space in which the detection module 10 is provided.

The shielding portion 93 is a plate-like portion that protrudes from the irradiation side body portion 911 to the detection module 10 side. The shielding portion 93 is provided along a surface on a rear side of the casing 2. An inner surface on a rear side of the casing body 3 is formed with a metal, and thus, there is a possibility that stray light such as radiation light reflected at the transparent window 41 may be reflected on the inner surface on the rear side of the casing body 3 and erroneously ultimately incident on the detection unit 13. The shielding portion 93 shields light from the transparent window 41 toward the surface on the rear side of the casing body 3, so that occurrence of reflection of light on the inner surface on the rear side of the casing body 3 is prevented.

The dividing portion 94 is a plate-like portion that protrudes from a boundary between the irradiation side body portion 911 and the detection side body portion 912 in the body portion 91 toward the detection module 10 side. The dividing portion 94 is provided along an upper surface and a lower surface of the casing 2.

A rear end portion of the dividing portion 94 is connected to a lower end portion of the shielding portion 93. Further, a left end portion of the dividing portion 94 has a shape along a shape of the adjacent intermediate plate 15. Still further, a front end portion of the dividing portion 94 is constituted to be engaged with an end portion of the transparent window shielding plate 43. The dividing portion 94 divides inside of the casing 2 into the space 2a in which the irradiation unit 12 is provided and the space 2b in which the detection unit 13 is provided, along with the intermediate plate 15 and the transparent window shielding plate 43. The dividing portion 94 prevents stray light within the space 2a in which the irradiation unit 12 is provided inside the casing 2 from being incident on the space 2b in which the detection unit 13 is provided.

The reinforcing plate 95 is a triangular plate-like reinforcing member that protrudes from a lower surface of the dividing portion 94 and a left surface of the detection side body portion 912. The reinforcing plate 95 is provided along a surface on the rear side of the casing 2. The reinforcing plate 95 prevents the dividing portion 94 from tilting with respect to the body portion 91.

### 6. Advantages

According to the embodiment described in detail above, the following advantages can be obtained.

(6a) The distance measurement device 1 includes the light shielding member 9 constituted to shield stray light from the fixing member 8 for wiring portion toward the detection unit 13. According to such a configuration, the stray light reflected at the fixing member 8 for wiring portion is less likely to be detected at the detection unit 13, which prevents degradation of distance measurement accuracy of the distance measurement device 1.

(6b) The light shielding member 9 includes the guide surface 912a constituted to guide the wiring portion 5b to the rear side of the casing 2. According to such a configuration, in a situation in which the cover 4 is assembled to the casing body 3, the wiring portion 5b is guided toward the drawing hole 31 with the guide surface 912a, so that it is possible to smoothly assemble the cover 4 to the casing body 3.

(6c) The fixing member 8 for wiring portion is provided in the integrated portion 5h obtained by integrating the portion 5f extending from the irradiation side heater portion 5c and the portion 5g extending from the detection side heater portion 5d in the wiring portion 5b. According to such a configuration, the wiring portion 5b can be fixed to the casing 2 with one fixing member 8 for wiring portion.

### 7. Other Embodiments

While the embodiment of the present disclosure has been described above, it goes without saying that the present disclosure is not limited to the above-described embodiment and can take various forms.

(7a) The fixing member 8 for wiring portion that fixes the wiring portion 5b within the casing 2 is not limited to the adhesive tape described in the above-described embodiment. For example, the fixing member 8 for wiring portion may be a curable adhesive or may be a metal fitting for fixing.

(7b) While in the above-described embodiment, the wiring portion 5b is fixed on the inner surface of the casing 2, a position where the wiring portion 5b is fixed within the casing 2 is not limited to this. For example, the wiring portion 5b may be fixed to the light shielding member 9.

(7c) While in the above-described embodiment, the distance measurement device 1 is mounted on the front portion of the vehicle, a position where the distance measurement device 1 is mounted is not limited to this. For example, the distance measurement device 1 may be mounted on a circumferential portion such as a side portion and a rear portion of the vehicle.

(7d) A function of one component in the above-described embodiment may be distributed as a plurality of components, or functions of a plurality of components may be integrated into one component. Further, part of the configurations of the above-described embodiment may be omitted. Still further, at least part of the configurations of the above-described embodiment may be added, replaced, or the like, with respect to other configurations of the above-described embodiment.

What is claimed is:

1. A distance measurement device for measuring a distance to an object, the distance measurement device comprising:
a detection module comprising an irradiation unit configured to radiate radiation light for performing scanning along a scanning direction set in advance, and a detection unit configured to detect reflected light from the object, arriving from a scanning region;
a casing configured to store the detection module;
a transparent window which is part of the casing and disposed so as to face the detection module, and through which the radiation light and the reflected light pass; and
a flexible substrate on which a heater wire that heats the transparent window is formed,
wherein the flexible substrate comprises a heater portion in which the heater wire is formed and which is fixed to the transparent window, and a wiring portion in which a wiring to the heater wire is formed and which extends to a rear side of the casing with a side on which the transparent window is provided in the casing being a front side, and
the distance measurement device further comprises:
a fixing member configured to fix the wiring portion within the casing; and
a light shielding member configured to shield stray light from the fixing member toward the detection unit.

2. The distance measurement device according to claim 1,
wherein the light shielding member comprises a guide surface configured to guide the wiring portion to the rear side of the casing.

3. The distance measurement device according to claim 1,
wherein the heater wire comprises:
an irradiation side heater wire configured to heat a region through which the radiation light passes; and
a detection side heater wire configured to heat a region through which the reflected light to be detected by the detection unit passes,
the flexible substrate is divided into an irradiation side heater portion in which the irradiation side heater wire is formed, and a detection side heater portion in which the detection side heater wire is formed in the heater portion,
the wiring portion comprises a integrated portion obtained by integrating a portion extending from the irradiation side heater portion and a portion extending from the detection side heater portion, and
the fixing member is provided in the integrated portion.
